(19) United States
(12) Patent Application Publication
(10) Pub. No.: US 2014/0205701 A1
(43) Pub. Date: Jul. 24, 2014

(54) MOLDING ROLLER, APPARATUS AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 13/952,862

(22) Filed: Jul. 29, 2013

(30) Foreign Application Priority Data
Jan. 24, 2013 (TW) 102102560

(51) Int. Cl. B30B 3/00; B29D 99/00

(52) U.S. Cl. CPC B30B 3/005; B29D 99/0032
USPC 425/296; 425/471; 264/163

(57) ABSTRACT

A molding roller includes a cylindrical main body and a flexible molding film. The main body has a circumferential surface. The molding film is wound around and is fixed to the circumferential surface. The molding film has a molding surface defining a number of molding patterns. The molding film is made of flexible organic-inorganic composite.

### BACKGROUND

1. Technical Field

The present disclosure relates to a molding roller, an apparatus and a method for manufacturing the molding roller.

2. Description of Related Art

Optical films include a number of micro structures. One method for forming the micro structures is a roll forming process using a metal roller. The metal roller has a circumferential surface including molding patterns for forming the micro structures. The molding pattern is formed by a laser knife. However, it is difficult to machine the molding patterns on a curved surface of the metal roller, therefore, the machining efficiency is relatively low.

Therefore, it is desirable to provide a molding roller, an apparatus and a method for manufacturing the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 to FIG. 5 are flowcharts of a method for manufacturing a molding roller, according to a third exemplary embodiment.

### DETAILED DESCRIPTION

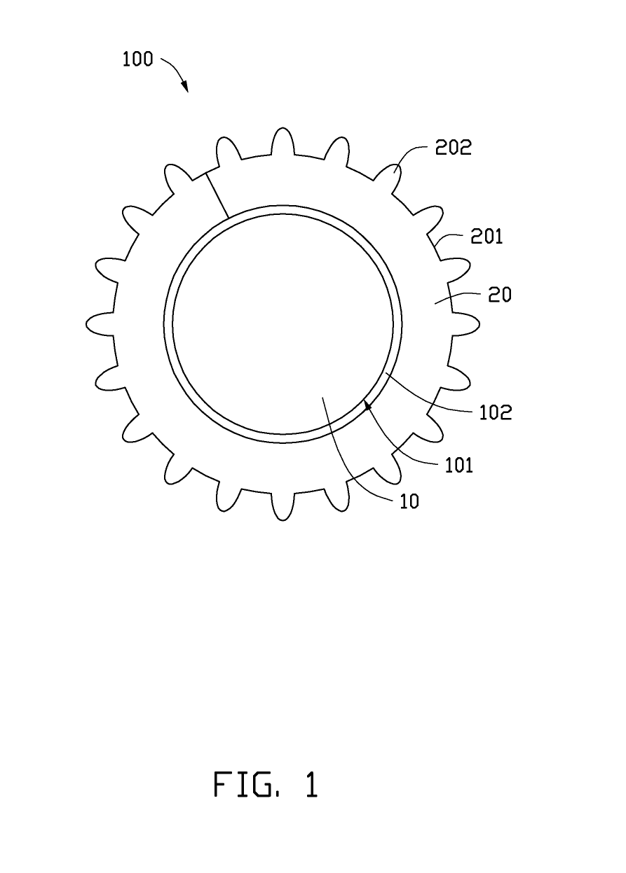

FIG. 1 illustrates a molding roller 100 in accordance with a first exemplary embodiment. The molding roller 100 includes a cylindrical main body 10 and a flexible molding film 20. The main body 10 includes a circumferential surface 101. The main body 10 can be made of stainless steel or other metals. The circumferential surface 101 is coated with an adhesive glue 102.

The molding film 20 is wound around and fixed to the circumferential surface 101 through the adhesive glue 102. The molding film 20 includes a molding surface 201 opposite to the main body 10. The molding surface 201 includes a number of molding patterns 202. In the embodiment, the molding patterns 202 are micro striped protrusions. In other embodiments, the molding patterns 202 also can be micro-dots, or micro domes.

The molding film 20 is made of flexible organic-inorganic composite. In this embodiment, the organic-inorganic composite consists of poly-ether-ether-ketone (PEEK), carbon fiber, graphite, and polytetrafluoroethylene (PTFE). The weight of the PEEK is about 70% of the total weight of the organic-inorganic composite. The sum of the weight of the carbon fiber, the weight of the graphite and the weight of the PTFE is about 30% of the total weight of the organic-inorganic composite. Because the organic-inorganic composite is easily separated from the optical films, therefore, the molding film 20 is easily separated from optical films, and the quality of the optical films can be greatly improved.

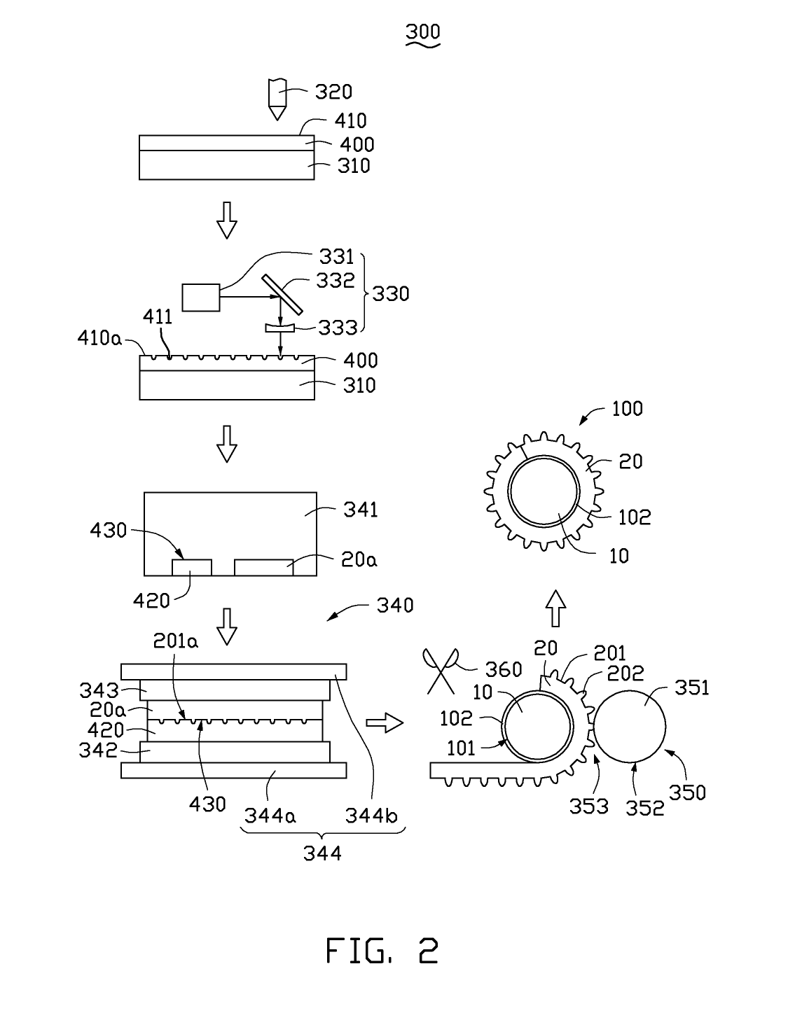

FIG. 2 illustrates an apparatus 300 for manufacturing the molding roller 100, according to a second exemplary embodiment. The apparatus 300 includes a loading plate 310, a polishing device 320, a processing device 330, a hot pressing device 340, a mounting device 350, and a cutting device 360.

The loading plate 310 is used for loading a preprocessed metal plate 400. The preprocessed metal plate 400 has a planar preprocessed impression surface 410 opposite to the loading plate 310. The preprocessed metal plate 400 can be made of nickel, chrome, or stainless steel.

The polishing device 320 is used for polishing the preprocessed impression surface 410 to obtain a smooth polished impression surface 410a. The polishing device 320 can include a diamond knife.

The processing device 330 is used for forming a number of impression patterns 411 on the polished impression surface 410a, thus obtaining a metal plate 420 with an impression surface 430. In the embodiment, the impression patterns 411 are micro-grooves.

The processing device 330 includes a laser emitter 331, a reflector 332, and a converging lens 333. The laser emitter 331 is used for emitting laser beams. The emitting direction of the laser beams is substantially parallel to the polished impression surface 410a. The reflector 332 reflects the laser beams to the converging lens 333. The converging lens 333 converges the laser beams from the reflector 332 on the polished impression surface 410a to form the impression patterns 411. In other embodiments, the reflector 332 and the converging lens 333 can be omitted, and the emitting direction of the laser beams is substantially perpendicular to the polished impression surface 410a. If the impression patterns 411 are V-shaped grooves, the processing device 330 can include a diamond knife having a V-shaped blade.

The hot pressing device 340 is used for forming the molding patterns 202 on a preprocessed molding surface 201a of a preprocessed molding film 20a to obtain the molding film 20. The hot pressing device 340 includes a preheating device 341, a substrate 342, a pressing plate 343, and a temperature adjusting device 344.

The preheating device 341 is used for heating the preprocessed molding film 20a and the metal plate 420 at a first predetermined temperature (such as 150° C.) for a first predetermined period (such as 3 hours), and thus to remove air bubbles of the preprocessed molding film 20a. The preheating device 341 can be an oven.

The metal plate 420 and the preprocessed molding film 20a are sandwiched between the substrate 342 and the pressing plate 343. The metal plate 420 is positioned on the substrate 342, and the impression surface 430 is opposite to the substrate 342. The preprocessed molding surface 20a is in contact with the impression surface 430. The pressing plate 343 is directly pressed on the preprocessed molding film 20a. The pressing plate 343 presses the preprocessed molding film 20a at a predetermined pressure, and thus the preprocessed molding surface 201a forms a number of molding patterns 202 mated with the impression patterns 430.

The temperature adjusting device 344 is used for heating or cooling the preprocessed molding film 20a, and includes a first portion 344a and a second portion 344b. The first portion 344a is under the substrate 342, and is directly in contact with the substrate 342. The second portion 344b is above the pressing plate 343, and is directly in contact with the pressing plate 343. The first portion 344a and the second portion 344b directly adjust the temperature of the substrate 342 and the temperature of the pressing plate 343, and thus the temperature of the metal plate 420 and the temperature of the preprocessed molding film 20a can be adjusted.

The working process of the hot pressing device 340 is described as follows: the preheating device 341 heats the preprocessed molding film 20a and the metal plate 420 at the first predetermined temperature (such as 150° C.). Then the temperature adjusting device 344 heats the preprocessed molding film 20a and the metal plate 420 at a second predetermined temperature (such as 390° C.), the pressing plate 343 presses the preprocessed molding film 20a at the predetermined pressure (such as 700 Pa). In addition, the preprocessed molding film 20a is kept constant at the predetermined pressure. The temperature adjusting device 344 cools the preprocessed molding film 20a at a predetermined speed (such as 40° C. per hour) until the temperature of the metal plate 420 reaches a room temperature, and thus the preprocessed molding surface 201a forms a number of molding patterns 202 mated with the impression patterns 411.

The mounting device 350 is used for mounting the molding film 20 on the circumferential surface 101, and includes an auxiliary roller 351 having a smooth circumferential surface 352. The auxiliary roller 351 is at a predetermined distance from the main body 10 to form a molding channel 353. The auxiliary roller 341 and the main body 10 are rotated in reverse directions. The circumferential surface 101 is coated with adhesive glue 102. One end of the molding film 20 is adhered on the circumferential surface 101, then the main body 10 and the auxiliary roller 351 are rotated to make the molding film 20 pass through the molding channel 353, and thus the molding film 20 is adhered to the circumferential surface 101 via the adhesive glue 102.

The cutting device 350 cuts the molding film 20 until the molding film 20 is wound around the main body 10.

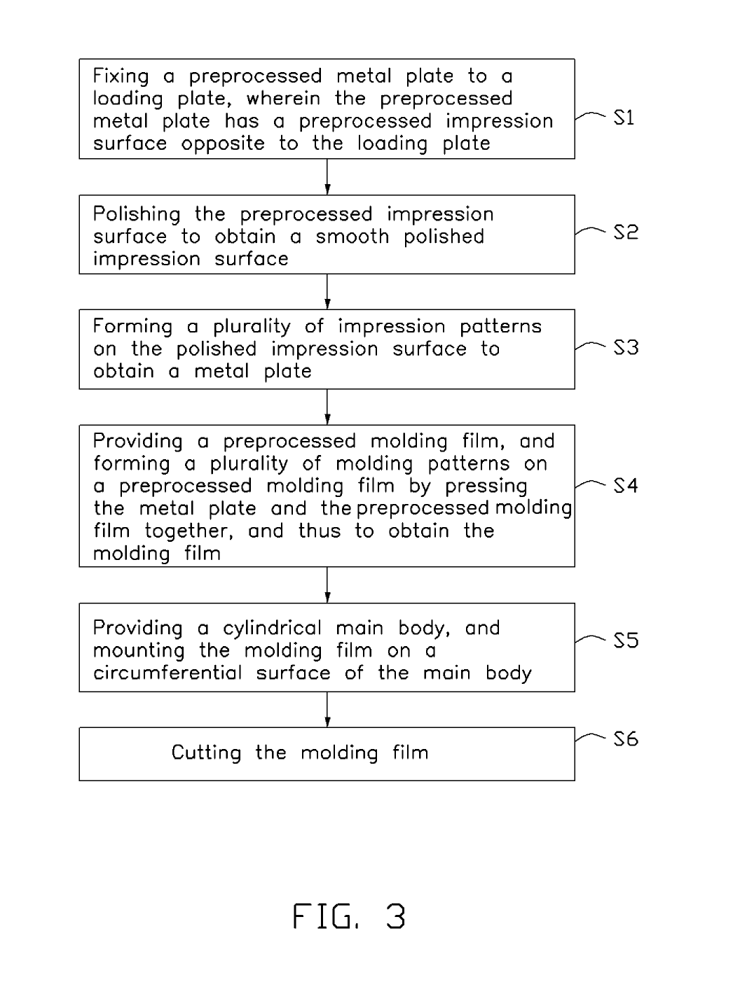

FIG. 3 illustrates a method for manufacturing the roller 100 using the apparatus 200. The illustrated method includes the following steps.

In step S1, the preprocessed metal plate 400 is fixed to the loading plate 310. The preprocessed metal plate 400 has a preprocessed impression surface 410 opposite to the loading plate 310.

In step S2, the preprocessed impression surface 410 is polished using the polishing device 320, and thus the polished impression surface 410a is obtained.

In step S3, the polished impression surface 410a is processed to form a number of impression patterns 411, and thus the metal plate 420 with the impression surface 430 is obtained.

In step S4, the metal plate 420 is separated from the loading plate 310. The preprocessed molding film 20a is provided, and the molding patterns 202 are formed on the preprocessed molding surface 201a of the preprocessed molding film 20a using the hot pressing device 340 by pressing the metal plate 420 and the preprocessed molding film 20a together, and thus the molding film 20 is obtained. The molding film 20 has a molding surface 201 having the molding patterns 202.

In step S5, the molding film 20 is wound around and is fixed to the circumferential surface 101 using the mounting device 350.

In step S6, the molding film 20 is cut by the cutting device 360.

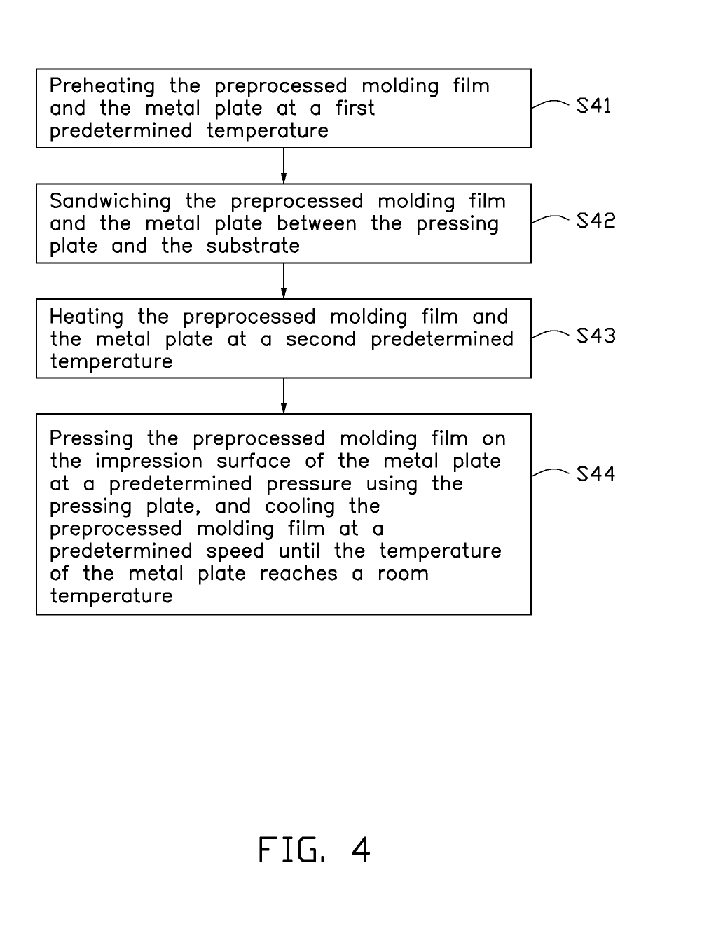

Referring to FIG. 4, step S4 includes the following sub-steps.

In step S41, the preprocessed molding film 20a and the metal plate 420 are heated at a first predetermined temperature (such as 150° C.) using the preheating device 341.

In step S42, the preprocessed molding film 20a and the metal plate 420 are sandwiched between the pressing plate 343 and the substrate 342.

In step S43, the temperature adjusting device 344 heats the preprocessed molding film 20a and the metal plate 420 at a second predetermined temperature (such as 390° C.).

In step S44, the pressing plate 343 presses the preprocessed molding film 20a at the predetermined pressure (such as 700 Pa), at the same time, the temperature adjusting device 344 cools the preprocessed molding film 20a at a predetermined speed (such as 40° C. per hour) until the temperature of the metal plate 420 reaches a room temperature.

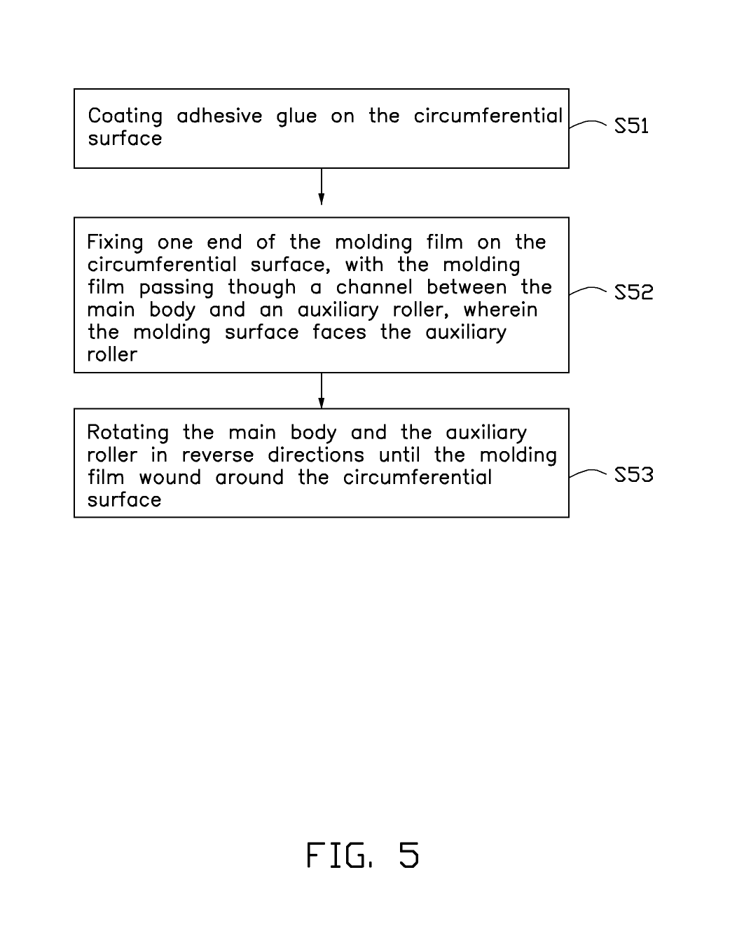

FIG. 5 illustrates that the step S5 further includes the following sub-steps.

In step S51, the circumferential surface 101 is coated with the adhesive glue 102.

In step S52, one end of the molding film 20 is adhered on the circumferential surface 101, and the molding surface 201 faces the auxiliary roller 351.

In step S53, the main body 10 and the auxiliary roller 351 are rotated in reverse directions to make the molding film 20 pass through the molding channel 353 until the molding film 20 is wound around the circumferential surface 101.

By employing the apparatus 100 and the above described method, it is easier for the processing device 330 to machine the impression patterns 411 on the planar polished impression surface 410a of the preprocessed metal plate 400 relative to on a curved surface of the metallic roller in the related art, therefore, the machining efficiency is improved. Furthermore, when the molding patterns 202 of one molding film 20 are destroyed, the destroyed molding film 20 can be removed from the main body 10. Another new molding film 20 can be adhered to the main body 10 to form a new molding roller 100. Therefore, the main body 10 can be used more times, and the molding roller 100 has a relatively low cost.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a circumferential surface; and
a flexible molding film wound around and fixed to the circumferential surface, the molding film having a molding surface defining a plurality of molding patterns;
wherein the molding film is made of flexible organic-inorganic composite.

2. The molding roller of claim 1, wherein the organic-inorganic composite consists of poly-ether-ether-ketone, carbon fibers, graphite, and polytetrafluoroethylene.

3. The molding roller of claim 2, wherein the weight of the poly-ether-ether-ketone is 70% of the total weight of the organic-inorganic composite, the sum of the weight of the carbon fiber, the weight of the graphite, and the weight of the polytetrafluoroethylene is 30% of the total weight of the organic-inorganic composite.

4. The molding roller of claim 1, wherein the main body is made of metal.

5. The molding roller of claim 1, wherein the circumferential surface is coated with an adhesive glue, and the molding film is fixed to the circumferential surface through the adhesive glue.

6. An apparatus for manufacturing a molding roller, comprising:
a loading plate configured for loading a preprocessed metal plate, and the preprocessed metal plate having a preprocessed impression surface opposite to the loading plate;
a polishing device configured for polishing the preprocessed molding surface to obtain a smooth polished impression surface;
a processing device configured for forming a plurality of impression patterns on the polished impression surface to obtain a metal plate having an impression surface;
a hot pressing device configured for forming a plurality of molding patterns on a preprocessed molding film to obtain the molding film by pressing the metal plate and the preprocessed molding film together;
a mounting device configured for mounting the molding film to a circumferential surface of a main body until the molding film is wound around the circumferential surface; and
a cutting device configured for cutting the molding film.

7. The apparatus of claim 6, wherein the hot pressing device comprises a preheating device, a substrate, a pressing plate, and a temperature adjusting device, the preheating device is configured for preheating the metal plate and the preprocessed molding film at a first predetermined temperature for a first predetermined period, the substrate and the pressing plate are configured for cooperatively pressing the metal plate and the preprocessed molding film therebetween; and the temperature adjusting device is configured for heating or cooling the preprocessed molding film.

8. The apparatus of claim 7, wherein the temperature adjusting device is configured for heating the substrate and the pressing plate at a second predetermined temperature, then the pressing plate presses the preprocessed molding film at a predetermined pressure for a second predetermined period, at the same time, the temperature adjusting device cools the metal plate and the processed molding film at a predetermined speed until the temperature of the metal plate and the temperature of the preprocessed molding film reach a room temperature.

9. The apparatus of claim 6, wherein the mounting device comprises an auxiliary roller spaced a predetermined distance from the main body to form a channel between the auxiliary roller and the main body, the main body and the auxiliary roller rotate in two reverse directions, the circumferential surface is coated with an adhesive glue.

10. A method for manufacturing a molding roller, comprising:
placing a preprocessed metal plate to a loading plate, wherein the preprocessed metal plate has a preprocessed impression surface opposite to the loading plate;
polishing the preprocessed impression surface to obtain a smooth polished impression surface using a polishing device;
forming a plurality of impression patterns on the polished impression surface to obtain a metal plate by using a processing device;
providing a preprocessed molding film;
forming a plurality of molding patterns on a preprocessed molding film by pressing the metal plate and the preprocessed molding film together using a hot pressing device, so as to obtain the molding film;
providing a cylindrical main body;
mounting the molding film on a circumferential surface of the main body using a mounting device, wherein the molding patterns are opposite to the circumferential surface; and
cutting the molding film using a cutting device.

11. The method of claim 10, wherein the step of forming a plurality of molding patterns on a preprocessed molding film by pressing the metal plate and the preprocessed molding film together to obtain the molding film comprises:
preheating the preprocessed molding film and the metal plate at a first predetermined temperature using a preheating device;
sandwiching the preprocessed molding film and the metal plate between a pressing plate and a substrate;
heating the preprocessed molding film and the metal plate at a second predetermined temperature using a temperature adjusting device; and
pressing the preprocessed molding film on the impression surface of the metal plate at a predetermined pressure using the pressing plate, and at the same time, cooling the preprocessed molding film at a predetermined speed until the temperature of the metal plate reaches a room temperature.

12. The method of claim 10, wherein the step of mounting the molding film on a circumferential surface of a main body further comprises:
coating adhesive glue on the circumferential surface;
fixing one end of the molding film on the circumferential surface, with the molding film passing though a channel between the main body and an auxiliary roller, wherein the molding surface faces the auxiliary roller; and
rotating the main body and the auxiliary roller in reverse directions until the molding film is wound around the circumferential surface of the main body.
